(19) United States
(12) Patent Application Publication
(10) Pub. No.: US 2026/0021724 A1
(43) Pub. Date: Jan. 22, 2026

(54) CHARGING DEVICE

(71) Applicant: LG ELECTRONICS INC., Seoul (KR)

(72) Inventors: Suk KO, Seoul (KR); Sunghwan OH, Seoul (KR); Myoungku LEE, Seoul (KR); Kangsuk LEE, Seoul (KR); Cheolhong PARK, Seoul (KR)

(73) Assignee: LG ELECTRONICS INC., Seoul (KR)

(21) Appl. No.: 18/886,280

(22) Filed: Sep. 16, 2024

(30) Foreign Application Priority Data
Jul. 22, 2024 (KR) 10-2024-0096177

(51) Int. Cl. B60L 53/302

(52) U.S. Cl. CPC B60L 53/302

(57) ABSTRACT

A charging device may include a main body comprising a cable connected charger, an accommodation space located inside the main body, the accommodation space being configured to accommodate a cooler, a lower plate located at a lower portion of the accommodation space, and a support plate coupled to the lower plate, the support plate being configured to support a lower portion of the cooler.

Pursuant to 35 U.S.C. § 119(a), the present application claims the benefit of earlier filing date and right of priority to Korean Application No. 10-2024-0096177, filed, in the Republic of Korea, on Jul. 22, 2024, the contents of which are hereby incorporated by reference herein in their entirety.

### BACKGROUND OF THE DISCLOSURE

### Field of the Disclosure

The present embodiments relate to a charging device, and more particularly, to a charging device that provides efficient coupling of a cooler.

### Discussion of the Related Art

In general, Electric Vehicles (EVs) have not been put to practical use for a long time due to problems such as heavy weight of a battery mounted in a vehicle and a charging time of the battery and the like compared to gasoline or diesel vehicles. However, due to the recent depletion of fossil energy and environmental pollution, research and development have been actively conducted as interest in electric vehicles that do not use fossil energy and use electric energy has increased.

As a result, the spread of electric vehicles is increasing in recent years. An electric vehicle includes a battery that supplies power for driving, and has a structure in which power is stored in the battery. Therefore, in order to continuously operate the electric vehicle, the battery should be charged. Accordingly, an infrastructure for charging an electric vehicle is required, and fixedly installed standing charging facilities are being provided in various places to meet the increasing demand for electric vehicles.

In particular, a chiller has recently been used for a charging device of an electric vehicle. The chiller is a part of the infrastructure of a charging device for an electric vehicle and is mainly used to manage and control heat generated during charging.

Therefore, the chiller has to be installed inside the charging device, but there is a problem that a worker has difficulty in installing the chiller due to the heavy weight of the chiller.

### SUMMARY OF THE DISCLOSURE

Accordingly, embodiments of the present disclosure are directed to a charging device that substantially obviates one or more problems due to limitations and disadvantages of the related art.

One object of the present disclosure is to provide a charging device that guides a chiller to be coupled to a desired position efficiently with case.

Another object of the present disclosure is to provide a charging device capable of efficiently using an accommodation space for accommodating a chiller therein.

Tasks to be solved by the present disclosure are not limited to the above-mentioned tasks, and other unmentioned tasks will be clearly understood by those skilled in the art from the following description.

Additional advantages, objects, and features of the disclosure will be set forth in the disclosure herein as well as the accompanying drawings. Such aspects may also be appreciated by those skilled in the art based on the disclosure herein.

To achieve these objects and other advantages and in accordance with the purpose of the disclosure, as embodied and broadly described herein, a charging device according to the present disclosure may include a main body having a cable connected charger located therein, an accommodation space formed inside the main body to accommodate a cooler in a first direction, a lower plate forming a lower portion of the accommodation space, and a support plate coupled to the lower plate to support a lower portion of the cooler.

The support plate may include a pair of plates extending in the first direction and located by being spaced apart from each other.

A pair of the plates may include guide parts protruding at a predetermined height from a pair of the plates and extending in the first direction, respectively.

A distance between the guide parts may correspond to a length in a second direction vertical to the first direction of the cooler or may be formed longer than the length in the second direction of the cooler.

The cooler may include a fixing member extending in the second direction from the lower portion of the cooler and a distance between the guide parts may correspond to a sum of the length in the second direction of the cooler and a length in the second direction of the fixing member.

The guide part may meet a side surface of the cooler to guide the cooler to move in the first direction.

A pair of the plates may include prevention parts protruding at a predetermined height from a pair of the plates to extend in a second direction vertical to the first direction, respectively.

The prevention part may be formed on a same line based on the second direction.

The prevention part may meet a rear surface of the cooler to prevent the cooler from moving in the first direction.

The support plate may further include a pair of bent parts bent from both ends of a pair of the plates toward the lower plate, respectively and extension parts extending from a pair of the bent parts in a direction parallel to a pair of the plates, respectively.

The support plate may extend in a second direction vertical to the first direction to linearly move in the first direction.

The charging device may further include a guide rail coupled to both side surfaces of the support plate to guide the support plate to move linearly in the first direction.

The charging device may further include a power line accommodated in the accommodation space to supply power to the charger, and the cooler and the power line may be located side by side based on a second direction vertical to the first direction.

The cooler may include a supply cable supplying cooling water to the cable and the main body may include a cable guide member coupled to a side surface inside to guide a fixed position of the supply cable.

Further, the cable guide member may be formed in an area above the accommodation space.

Accordingly, the present disclosure provides the following effects and/or advantages.

According to embodiments, a worker may easily fix/install a chiller by providing a charging device that guides the chiller to be efficiently and easily coupled to a desired position.

According to embodiments, by providing a charging device that may efficiently use an accommodation space in which a chiller is accommodated, a worker may efficiently utilize the accommodation space in the field area.

The effects obtained by the present disclosure are not limited to the above-mentioned effects, and other effects not mentioned will be clearly understood by those skilled in the art to which the present disclosure pertains from the following description.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of the present application, illustrate embodiment(s) of the disclosure and together with the description serve to explain the principle of the disclosure. The above and other aspects, features, and advantages of the present disclosure will become more apparent upon consideration of the following description of embodiments, taken in conjunction with the accompanying drawing figures. In the drawings:

FIG. 1 is a diagram illustrating a charging device according to embodiments;

FIG. 2 is a diagram illustrating a state in which a front door of a charging device according to embodiments is open;

FIG. 3 is a diagram illustrating one embodiment of a support plate of a charging device according to embodiments;

FIG. 4 and FIG. 5 are diagrams illustrating a state in which a cooler is accommodated on a support plate of the charging device according to the embodiments shown in FIG. 3;

FIG. 6 and FIG. 7 are diagrams illustrating another example of a support plate of a charging device according to embodiments;

FIG. 8 and FIG. 9 are diagrams illustrating a state in which a cooler is accommodated on a support plate of the charging device according to the embodiments shown in FIG. 7;

FIG. 10 is a diagram illustrating a coupled state of a power line of a charging device according to embodiments; and

FIG. 11 is a diagram illustrating a fixed state of a supply cable of a charging device according to embodiments.

### DETAILED DESCRIPTION OF THE DISCLOSURE

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant technologies of the related art may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

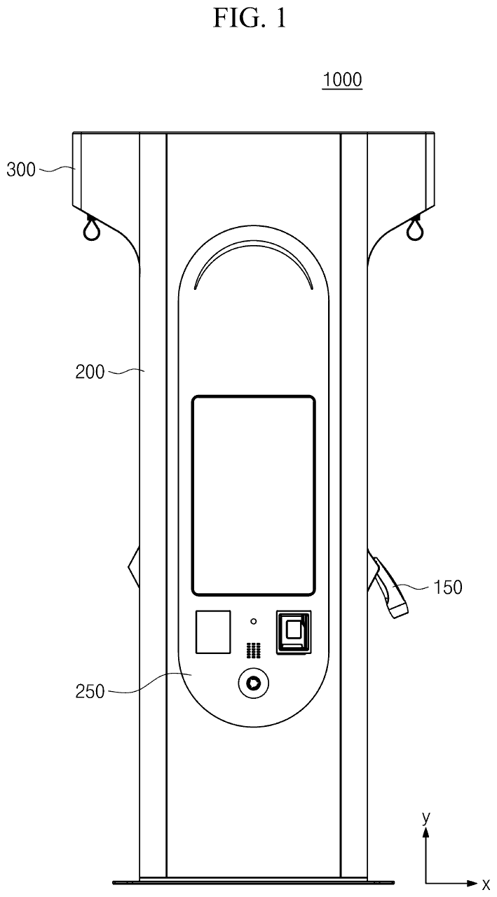

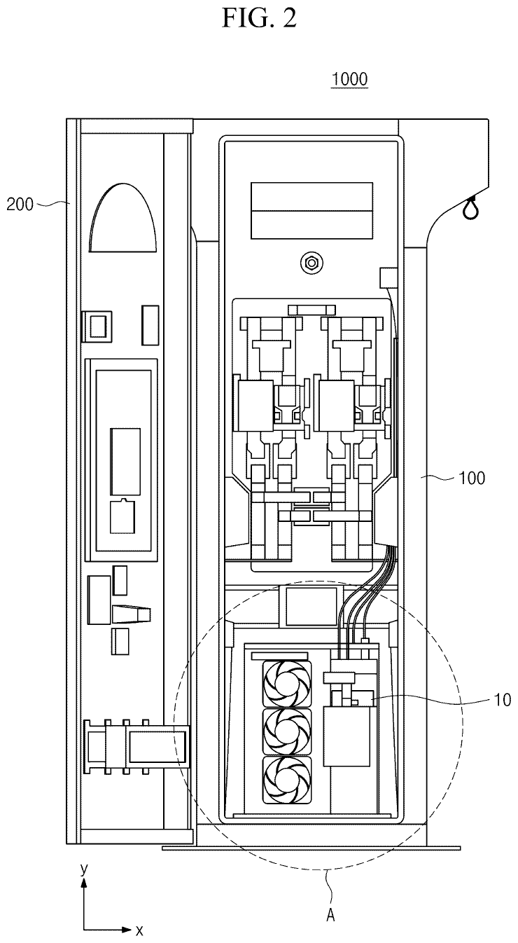

FIG. 1 is a diagram illustrating a charging device according to embodiments. FIG. 2 is a diagram illustrating a state in which a front door of a charging device according to embodiments is open.

A charging device 1000 shown in FIG. 2 corresponds to the charging device 1000 shown in FIG. 1.

Hereinafter, in describing the charging device 1000 according to the embodiments, a horizontal direction is described based on an x-axis direction, a vertical direction is described based on a y-axis direction, and a direction toward a front surface and a rear surface is described based on a z-axis direction.

Referring to FIG. 1 and FIG. 2, a charging device 1000 according to embodiments may include a main body 100, a front door 200, a side cover 300, and the like.

The charging device 1000 according to the embodiments may be a type of device for charging an Electric Vehicle (EV). More specifically, the charging device 1000 according to the embodiments may correspond to an EV charger dispenser, which is one of devices used when charging the electric vehicle. A dispenser is a device that stores and protects a charging cable, and is generally installed in combination with a charger, and a user may pull the cable connected to the charger from the dispenser and connect the cable to the electric vehicle.

A charger 150 to which a cable is connected is positioned in the main body 100, and an LED indicator or screen indicating a charging state may be built in the main body 100. As illustrated in FIG. 1 and FIG. 2, the main body 100 may have a rectangular parallelepiped shape, and the front door 200, the side cover 300, and the rear cover 400 may cover a circumference thereof.

The front door 200 is configured to cover a front surface and a portion of a side surface 102 of the main body 100, and may display an LED indicator, a screen, or the like indicating a charging state. The rear cover 400 is configured to cover a rear surface of the main body 100.

The side cover 300 is configured to cover the rest of the side surface 102 of the main body 100, and may be provided in a pair on both sides of the main body 100. A retractor may be positioned within the side cover 300. The retractor is a device that safely stores a charging cable and helps a user to use it conveniently, and the side cover 300 that stores the retractor may cover an upper part of the side surface 102 of the main body 100 as shown in FIG. 1 and FIG. 2.

Furthermore, a cooler 10 may be mounted inside the main body 100. More specifically, the cooler 10 may be located at a lower end portion of the inside of the main body 100.

In general, a cable for a charger provided in a charging device may have a heavy weight because it uses a high current. In addition, since a cable having a heavy weight is heavy, there is a problem that usability is poor.

Therefore, in order to increase usability, a water-cooled cable that may effectively manage heat generated during a charging process by circulating cooling water/refrigerant inside the cable is used rather than a cable that uses high current as a cable for a charger. However, in order to use a water-cooled cable, the cooler 10 capable of cooling the cooling water/refrigerant inside the cable is required, and there is a problem that such a cooler 10 needs to be installed efficiently.

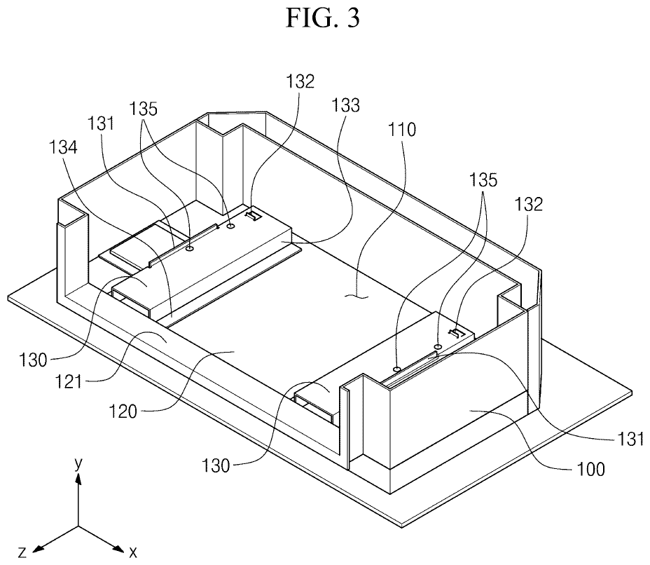

Accordingly, the charging device 1000 according to embodiments may include a support plate 130 and 140 that supports a lower portion of the cooler 10 to provide efficient and easy installation of the cooler 10. A detailed description thereof will be made with reference to FIGS. 3 to 10.

FIG. 3 shows an embodiment of a support plate of a charging device according to embodiments. More specifically, FIG. 3 is a diagram illustrating a state in which the cooler 10 is removed from a part ‘A’ of FIG. 2.

A main body 100 shown in FIG. 3 corresponds to the main body 100 shown in FIG. 1 and FIG. 2.

Referring to FIG. 3, a charging device 1000 according to embodiments may include a main body 100, an accommodation space 110, a lower plate 120, and a support plate 130.

The accommodation space 110 may be formed inside the main body 100 and may accommodate the cooler 10 (see FIG. 2) in a first direction. That is, the accommodation space 110 may refer to a space in which the cooler 10 is accommodated in the main body 100, and the first direction may refer to a +/−z-axis direction. In other words, the cooler 10 may be accommodated in the accommodation space 110 in a direction from a front surface to a rear direction.

The lower plate 120 is a member forming a lower portion of the accommodation space 110, and more specifically, the lower plate 120 may mean a lower surface of the inside of the main body 110. The lower plate 120 may include a stepped portion 121 in a front direction. An upper surface of the stepped portion 121 may form the same plane as an upper surface of the support plate 130.

The support plate 130 may be coupled to the lower plate 120 and may support a lower portion of the cooler 10. Referring to FIG. 3, the support plate 130 may include a pair of plates. Hereinafter, for convenience of description, a pair of the plates will be referred to as the support plate 130. That is, the support plate 130 may have the same configuration as a pair of the plates.

The support plate 130 may extend in the first direction, that is, the +/−z-axis direction, and may be spaced apart from each other. That is, the support plate 130 may support lower surfaces of both sides of the lower surface of the cooler 10.

As illustrated in FIG. 3, the support plate 130 may include a guide part 131, a prevention part 132, a bent part 133, an extension part 134 and a coupling hole 135. The guide part 131 may protrude from an upper surface of the support plate 130 at a predetermined height and extend in the first direction, that is, the +/−z-axis direction. For example, the guide part 131 may be formed on an edge forming the upper surface of the support plate 130.

In addition, since the support plate 130 consists of a pair of the plates, it may be desirable that a pair of the guide parts 131 are also included. In this case, a distance between a pair of the guide parts 131 may correspond to a length of the cooler 10 or may be formed longer than the length of the cooler 10. More specifically, the distance between a pair of the guide parts 131 may correspond to a horizontal length of the cooler 10, that is, the length of the cooler 10 in a +/−x-axis direction or may be formed longer than the length of the cooler 10.

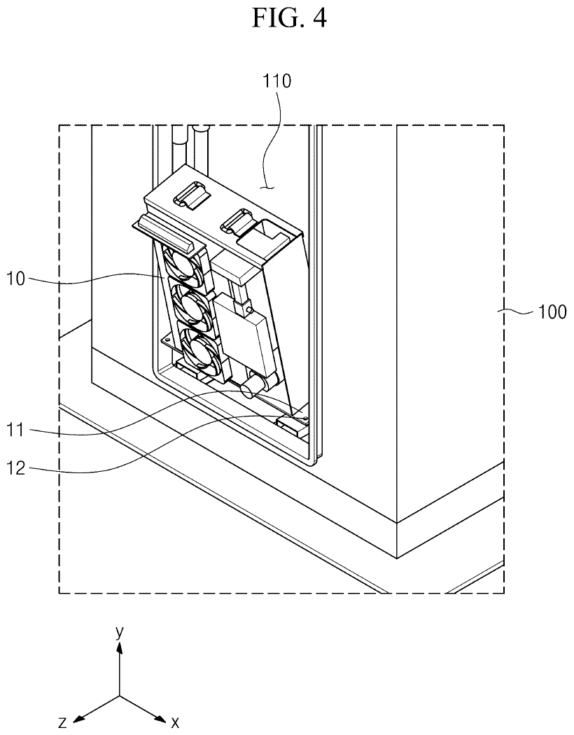

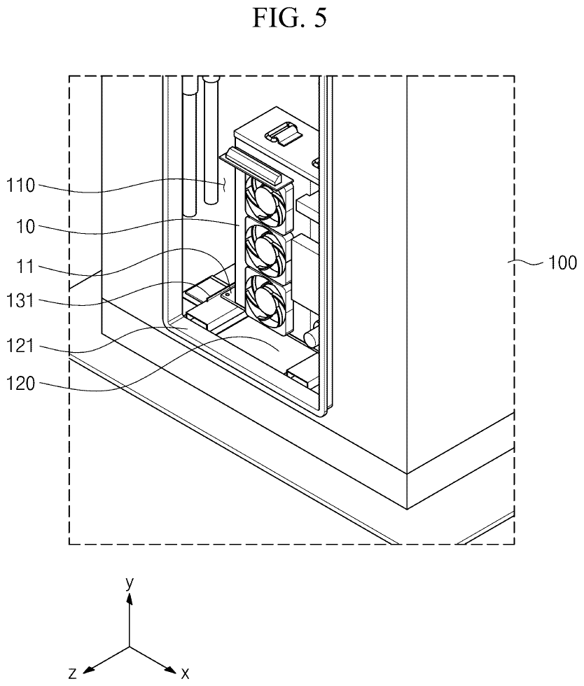

The guide part 131 may meet both side surfaces of the cooler 10. More specifically, when the cooler 10 is accommodated in the accommodation space 110, the guide part 131 may guide movement of the cooler 10 in a rear or front direction. A detailed description thereof will be made with reference to FIG. 4 and FIG. 5.

The prevention part 132 may protrude from the upper surface of the support plate 130 at a predetermined height and extend in a second direction vertical to the first direction, that is, the +/−x-axis direction. For example, the prevention part 132 may be formed close to a rear surface of the main body 100 in an upper surface of the support plate 130.

In addition, since the support plate 130 consists of a pair of the plates, it may be desirable that a pair of the prevention parts 132 are included like the guide parts 131. In this case, a pair of the prevention parts 132 may be formed on the same line based on the second direction, that is, the +/−x-axis direction. In other words, a pair of the prevention parts 132 may be formed in a line.

The prevention part 132 may meet a rear surface of the cooler 10. More specifically, movement of the cooler 10 in a rear direction may be prevented when the cooler 10 is accommodated in the accommodation space 110. A detailed description thereof will be made with reference to FIG. 4 and FIG. 5.

The bent part 133 may be formed to be bent toward the lower plate 120 from both ends of the support plate 130. That is, the bent part 133 may be bent from both ends of the support plate 130 in a −y-axis direction, and may consist of a pair. And, the extension part 134 may be formed to extend from each of a pair of the bent parts 133 in a direction parallel to the support plate 130. That is, the extension part 134 may be formed to extend in the +/−x-axis direction. Both the bent part 133 and the extension part 134 may be formed in a plate shape.

More specifically, the extension part 134 may be coupled to the lower plate 120. For example, the extension part 134 may be coupled to the lower plate 120 by bolt fastening or the like. As the extension part 134 is coupled to the lower plate 120, as a result, the support plate 130 may be coupled to the lower plate 120.

The coupling hole 135 may be formed in the upper surface of the support plate 130. The number of the coupling hole(s) 135 may be one or more. As a fastening member is inserted into the coupling hole 135, the cooler 10 may be fixedly coupled to the support plate 130. A detailed description thereof will be made with reference to FIG. 4 and FIG. 5.

FIG. 4 and FIG. 5 illustrate a state in which the cooler is accommodated on the support plate of the charging device according to the embodiments shown in FIG. 3.

More specifically, FIG. 4 is a diagram illustrating a process of accommodating the cooler 10 in the accommodation space 110, and FIG. 5 is a diagram illustrating a state in which the cooler 10 is completely accommodated in the accommodation space 110.

Referring to FIG. 4 and FIG. 5, the cooler 10 may include a fixing member 11 extending from a lower surface in the second direction, that is, in the +/−x-axis direction. The fixing member 11 may be formed in a plate shape. More specifically, the fixing member 11 may be formed to extend in the first direction, that is, in the +/−z-axis direction.

A coupling hole 12 may be formed in an upper surface of the fixing member 11. The coupling hole 12 formed in the upper surface of the fixing member 11 may be positioned to overlap the coupling hole 135 formed in the upper surface of the support plate 130 when the cooler 10 is completely accommodated in the accommodation space 110. A description thereof will be made in detail below.

First, referring to FIG. 4, a worker/user may push the cooler 10 toward the rear surface of the main body 100. In this case, as illustrated in FIG. 4, the worker/user may push the cooler 10 so that the front surface of the cooler 10 is in contact with the support plate 130 while the rear surface thereof is not in contact with the support plate 130. Alternatively, the worker/user may push the cooler 10 so that the rear surface of the cooler 10 is in contact with the support plate 130 while the front surface thereof is not contact with the support plate 130.

When the worker/user intends to put the cooler 10 in the accommodation space 110, a position of the cooler 10 before putting it in may be adjusted to be formed at a position where the side surface of the cooler 10 meets the guide part 131. That is, the cooler 10 may move to a desired position in the accommodation space 110 without changing a left-right direction as the side surface meets the guide part 131.

Alternatively, as shown in FIG. 4 and FIG. 5, when the cooler 10 includes the fixing member 11, the worker/user may adjust the position of the cooler 10 so that the fixing members 11 formed on both sides of the cooler 10 meets the guide parts 13, respectively.

That is, a distance between the guide parts 131 may correspond to a horizontal length of the cooler 10, or may correspond to the sum of the horizontal length of the cooler 10 and the length of the fixing members 11 formed on both sides.

Therefore, the charging device 1000 according to the embodiments has the effect of efficiently adjusting the coupling position of the cooler 10 by the guide part 131.

In addition, the worker/user may push the cooler 10 until the rear surface of the cooler 10 meets the prevention part 132. That is, the cooler 10 may move until it is unable to move in the rear direction due to the prevention part 132. Further, when the rear surface of the cooler 10 meets the prevention part 132, the worker/user may determine that the cooler 10 is completely accommodated in the accommodation space 110.

Therefore, the charging device 1000 according to the embodiments has the effect that the cooler 10 may be placed in a desired coupling position in the accommodation space 110 owing to the prevention part 132.

In addition, if the worker/user determines that the cooler 10 is fully accommodated in the accommodation space 110 by the guide part 131 and the prevention part 132, the cooler 10 may be coupled to the support plate 130 through a fastening member.

In other words, for example, the worker/user may fix the cooler 10 to the support plate 130 by simultaneously fastening bolts, screws, etc. to the coupling hole 12 formed in the fixing member 11 and the coupling hole 135 formed in the support plate 130.

In addition, referring to FIG. 5, even when the cooler 10 is completely accommodated in the accommodation space 110, a remaining space may be formed in the accommodation space 110 except for the space in which the cooler 10 is accommodated. In particular, the accommodation space 110 may include a remaining space formed in a front direction of the cooler 10.

Therefore, the charging device 1000 according to the embodiments has the effect of efficiently and easily installing/fixing the cooler 10 by the support plate 130 on which the guide part 13) is formed as well as utilizing the remaining space formed in the front direction of the cooler 10.

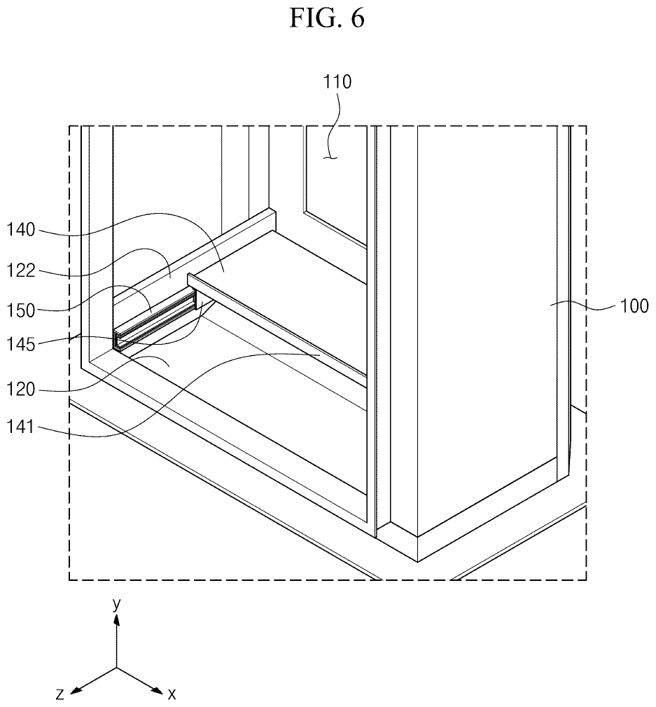

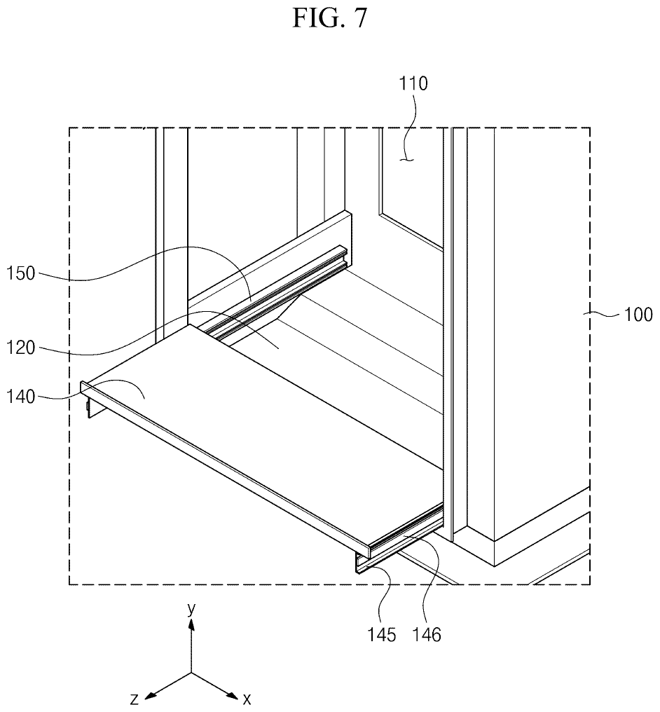

FIG. 6 and FIG. 7 show another example of a support plate of a charging device according to embodiments. More specifically, FIG. 6 and FIG. 7 are diagrams illustrating a state in which the cooler 10 is removed from the part A of FIG. 2.

A main body 100 shown in FIG. 6 and FIG. 7 corresponds to the main body 100 shown in FIG. 1 and FIG. 2.

Referring to FIG. 6 and FIG. 7, a charging device 1000 according to embodiments may include a main body 100, an accommodation space 110, a lower plate 120, a support plate 140, and a guide rail 150.

The accommodation space 110 may be formed inside the main body 100 and may accommodate the cooler 10 (see FIG. 2) in a first direction. That is, the accommodation space 110 may refer to a space in which the cooler 10 is accommodated in the main body 100, and the first direction may refer to a +/−z-axis direction. In other words, the cooler 10 may be accommodated in the accommodation space 110 from a front to rear direction.

The lower plate 120 is a member forming a lower part of the accommodation space 110, and more specifically, the lower plate 120 may mean a lower surface of the inside of the main body 110.

The lower plate 120 may have a stepped portion 121 formed in a front direction and side portions 122 formed on both side surfaces thereof. An upper surface of the stepped portion 121 may form the same plane as an upper surface of the support plate 130. The side portions 122 may be formed on both side surfaces of the lower plate 120 and may protrude in an upper surface direction, that is, in a y-axis direction.

The support plate 140 may be coupled to the lower plate 120 and may support a lower portion of the cooler 10. More specifically, the support plate 140 may be coupled to the lower plate 120 by being coupled to a side surface portion 122 formed in the lower plate 120.

The support plate 140 may extend in a second direction, that is, in a +/−x-axis direction, and may linearly move in the first direction, that is, in the +/−z-axis direction. That is, unlike the support plate 130 shown in FIGS. 3 to 5, the support plate 140 shown in FIG. 6 and FIG. 7 may move without being fixed. Also, unlike the support plate 130 shown in FIGS. 3 to 5, the support plate 140 may be formed as a single body rather than a pair.

The support plate 140 may have a prevention part 141 protruding at a predetermined height in the front direction. When the cooler 10 is seated on the support plate 140, the prevention part 141 may prevent the cooler 10 from moving in the front direction. That is, owing to the prevention part 141, even when the cooler 10 is seated on the support plate 140, the cooler 10 may not deviate from the support plate 140 by the linear movement of the support plate 140.

One surface of the guide rail 150 may be coupled to the side part 122 formed on each of both side surfaces of the lower plate 120, and the other surface may be coupled to the support plate 140. More specifically, one surface of the guide rail 150 may be coupled to the side part 122, and the other surface of the guide rail 150 may be coupled to a side plate 145 formed on the support plate 140.

As shown in FIG. 6 and FIG. 7, the side plates 145 may be formed on both sides of the lower portion of the support plate 140 and may protrude in the direction toward the lower plate 120. Also, the side plate 145 may include a slide member 146 that may be coupled to the guide rail 150.

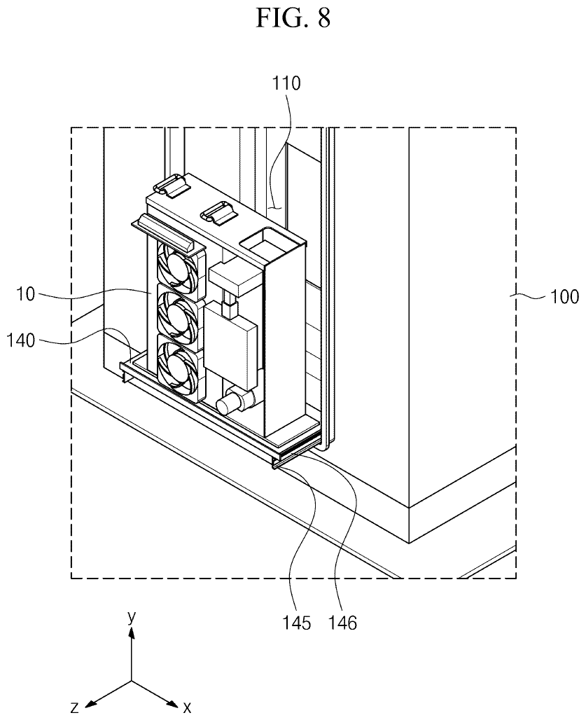

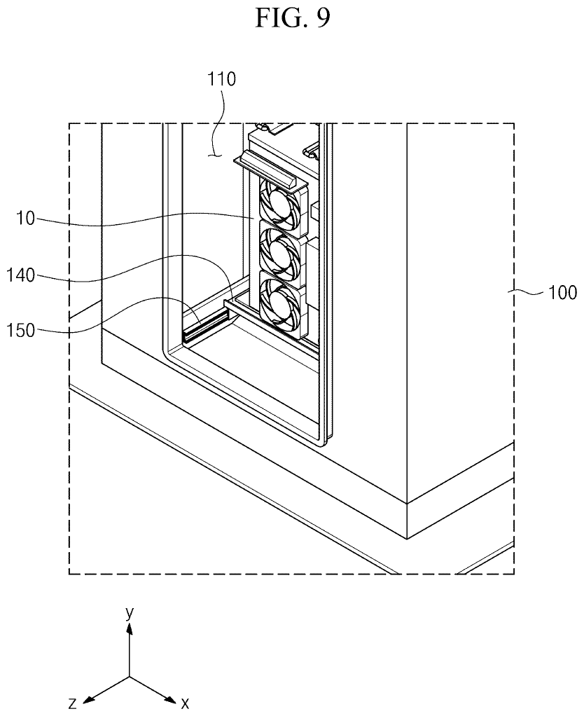

Namely, as the slide member 146 slides inside the guide rail 150, i.e., linearly moves in the +/−z-axis direction, the support plate 140 may linearly move in the +/−z-axis direction as well. A detailed description thereof will be made with reference to FIG. 8 and FIG. 9.

FIG. 8 and FIG. 9 illustrate a state in which the cooler is received on the support plate of the charging device according to the embodiments shown in FIG. 6 and FIG. 7.

More specifically, FIG. 8 is a diagram illustrating that the cooler 10 is seated on the support plate 140 shown in FIG. 7, and FIG. 9 is a diagram illustrating that the cooler 10 is seated on the support plate 140 shown in FIG. 6.

First, referring to FIG. 8, a worker/user may seat the cooler 10 on the support plate 140. In this case, the worker/user may adjust the position of the cooler 10 so that the front surface of the cooler 10 meets the prevention part 141.

In addition, the worker/user may push the support plate 140 in the rear direction after mounting the cooler 10 on the support plate 140. That is, the support plate 140 may be linearly moved in the rear direction by the guide rail 150, and as shown in FIG. 9, the cooler 10 may be accommodated in the accommodation space 110 owing to the linear movement of the support plate 140 in the rear direction.

Therefore, the charging device 1000 according to the embodiments has the effect of efficiently and easily fixing/coupling the cooler 10 by the guide rail 150 that guides the linear movement of the support plate 140.

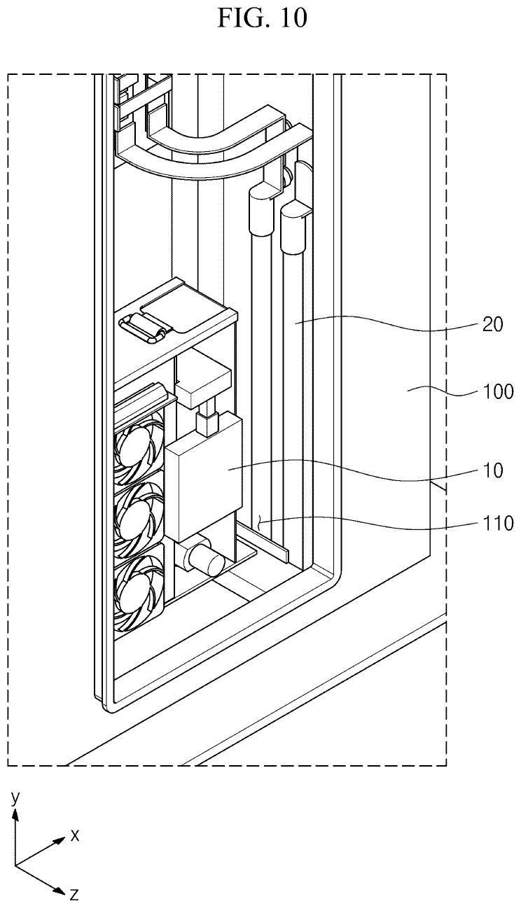

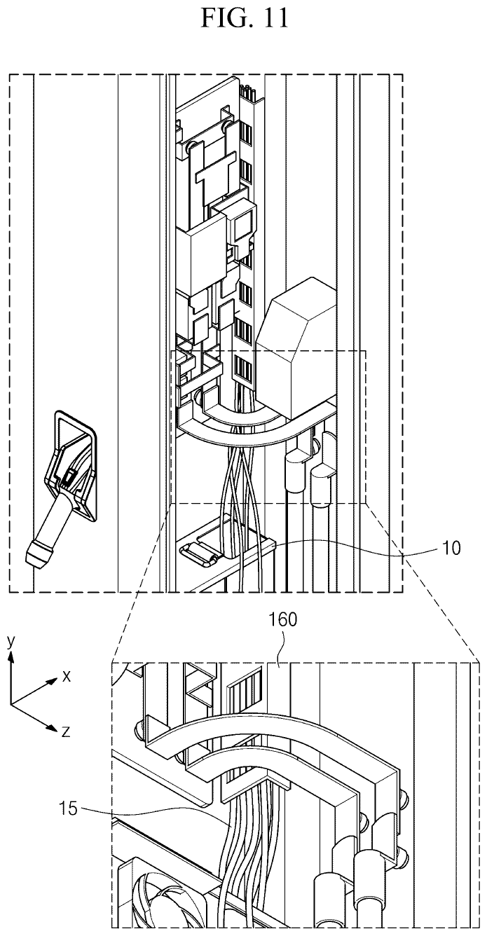

FIG. 10 illustrates a coupled state of a power line of a charging device according to embodiments. FIG. 11 illustrates a fixed state of a supply cable of a charging device according to embodiments.

Referring to FIG. 10, a charging device 1000 according to embodiments may include a power line 20 that supplies power to a charger 150 (refer to FIG. 1).

In this case, like a cooler 10, the power line 20 may be accommodated in an accommodation space 110. More specifically, the power line 20 may be located in a remaining space of the accommodation space 110 after the cooler 10 is accommodated. In particular, it may be that the power line 20 is located in a remaining space formed on both sides of the cooler 10 in the accommodation space 110.

Therefore, the charging device 1000 according to embodiments may efficiently use the inner space of a main body 100.

In addition, referring to FIG. 11, the cooler 10 may include a supply cable 15 for supplying cooling water to a cable connected to the charger 150. In addition, the main body 100 may include a cable guide member 160 coupled to an inner side surface and guiding a fixed position of the supply cable 15.

That is, the cable guide member 160 located on the inner side surface of the main body 100 may guide the supply cable 15 of the cooler 10 to be fixed toward a side surface of the inner space of the main body 100. In this case, the cable guide member 160 may be formed in an upper area of the inner space of the main body 100. In other words, the cable guide member 160 may be located in an area located above the accommodation space 110 in which the cooler 10 is accommodated.

Therefore, the charging device 1000 according to embodiments may have an effect of efficiently using the inner space of the main body 100.

The detailed description of the embodiments of the present disclosure disclosed as described above has been provided to allow those skilled in the art to embody and implement the present disclosure. Although the above has been described with reference to the embodiments of the present disclosure, those skilled in the art will understand that the present disclosure may be variously modified and changed without departing from the scope of the present disclosure. For example, those skilled in the art may use each of the components described in the above-described embodiments in a manner of combining them with each other.

Therefore, the present disclosure is not intended to be limited to the embodiments shown here, but to give a maximum scope consistent with the principles and new features disclosed herein.

What is claimed is:

1. A charging device, comprising:
a main body comprising a cable connected charger;
an accommodation space located inside the main body, the accommodation space being configured to accommodate a cooler;
a lower plate located at a lower portion of the accommodation space; and
a support plate coupled to the lower plate, the support plate being configured to support a lower portion of the cooler.

2. The charging device of claim 1, wherein the support plate comprises a pair of plates extending in a first direction, the pair of plates being spaced apart from each other.

3. The charging device of claim 2, wherein the pair of plates each comprise a guide part protruding at a predetermined height from the pair of plates, the guide part extending in the first direction.

4. The charging device of claim 3, wherein a distance between the guide parts is greater than or equal to a length of the cooler in a second direction perpendicular to the first direction.

5. The charging device of claim 3, wherein the cooler comprises a fixing member extending in a second direction from a lower portion of the cooler, the second direction being different from the first direction, and
wherein a distance between the guide parts corresponds to a sum of a length of the cooler in the second direction and a length of the fixing member in the second direction.

6. The charging device of claim 3, wherein the guide part is configured to guide a side surface of the cooler and restrict movement of the cooler in a second direction perpendicular to the first direction.

7. The charging device of claim 2, wherein the pair of plates each comprise a prevention part protruding at a predetermined height from the pair of plates to extend in a second direction perpendicular to the first direction, respectively.

8. The charging device of claim 7, wherein each prevention part is located on a same line in the second direction.

9. The charging device of claim 7, wherein the prevention part meets a rear surface of the cooler, the prevention part preventing the cooler from moving in the first direction.

10. The charging device of claim 2, wherein the support plate further comprises:
a pair of bent parts bent from both ends of the pair of plates toward the lower plate, respectively; and
extension parts extending from the pair of bent parts in a second direction perpendicular to the first direction.

11. The charging device of claim 1, wherein the support plate is configured to move in a first direction.

12. The charging device of claim 11, further comprising a guide rail coupled to both side surfaces of the support plate to guide the support plate to move in the first direction.

13. The charging device of claim 1, further comprising a power line accommodated in the accommodation space, the power line being configured to supply power to the cable connected charger,
wherein the cooler and the power line are located side by side based on a second direction.

14. The charging device of claim 1, wherein the cooler comprises a supply cable configured to supply cooling water to the cable connected charger, and
wherein the main body further comprises a cable guide member coupled to an inside side surface of the main body to guide a fixed position of the supply cable.

15. The charging device of claim 14, wherein the cable guide member is located in an area above the accommodation space in a third direction.

16. The charging device of claim 1, wherein the support plate comprises a pair of plates extending in a first direction, the pair of plates being spaced apart from each other at edge portions of the accommodation space.

17. The charging device of claim 16, wherein each of the pair of plates comprises:
an upper plate disposed above the lower plate;
a pair of bent parts bent from both ends of the upper plate; and
extension parts extending from the pair of bent parts, the extensions parts being located directly on the lower plate.

18. The charging device of claim 17, wherein the upper plate includes coupling holes configured to be coupled to the cooler.

19. The charging device of claim 1, wherein the support plate comprises a prevention part, and
wherein a length the prevention part in a second direction corresponds to a length of the support plate in the second direction.

20. The charging device of claim 19, wherein the prevention part is located at a front end of the support plate with respect to a first direction being perpendicular to the second direction, the prevention part being configured to restrict movement of the cooler with respect to the support plate in the first direction.
